(19) United States
(12) Patent Application Publication
(10) Pub. No.: US 2026/0328381 A1
(43) Pub. Date: Oct. 22, 2026

(54) LAMP WITH COMBINED LED LIGHTS

(71) Applicant: East West Basics (HK) Limited, New York, NY (US)

(72) Inventor: Li YONG, Dongguan City (CN)

(21) Appl. No.: 19/456,412

(22) Filed: Jan. 22, 2026

(30) Foreign Application Priority Data
Apr. 21, 2025 (CN) 2025207559886

(51) Int. Cl. F21V 33/00; F21S 4/20; F21S 9/02; F21V 3/06; F21V 17/12; F21V 23/00; F21V 23/02; F21V 23/06; H05B 45/10; H05B 45/20; H05B 47/16; F21Y 115/10

(52) U.S. Cl. CPC F21V 33/0056; F21S 4/20; F21S 9/02; F21V 3/061; F21V 17/12; F21V 23/009; F21V 23/023; F21V 23/06; H05B 45/10; H05B 45/20; H05B 47/16; F21Y 2115/10

(57) ABSTRACT

A lamp with combined LED lights including a mounting base, a lamp core tube mounted inside the mounting base, a cavity formed inside the lamp core tube, two groups of electrical sockets oppositely formed on both sides of an outer arc surface of the lamp core tube, a bottom socket formed at a bottom of the lamp core tube, a control module mounted inside the cavity corresponding to positions of the electrical sockets and the bottom socket, two groups of batteries placed inside the lamp core tube above the control module, a bottom LED lamp mounted at the bottom of the lamp core tube, an LED light strip mounted on one side of the lamp core tube, and an audio player mounted on the other side of the lamp core tube.

### TECHNICAL FIELD

This application relates to the technical field of LED lamps, in particular to a lamp with combined LED lights.

### BACKGROUND

At present, LED lamps on the market still have obvious deficiencies in terms of battery life, lighting effects and ornamental value. Traditional LED lamps mostly adopt a fixed power supply scheme, with limited built-in battery capacity and lack of intelligent power management, resulting in short battery life. Although some products have a timing switch function, the control method is single, and they cannot dynamically adjust the operation mode according to the usage scenario, causing waste of electrical energy.

In terms of lighting effects, most products only support fixed color temperature or limited RGB color adjustment, with rigid color change modes and insufficient dynamic light effect expression. Although some products provide basic breathing light or gradient effects, the switching of light effects is abrupt, lacking advanced interactive functions such as smooth transition and music rhythm.

Existing improvement schemes, such as simply increasing the battery capacity, will sacrifice the aesthetics of the product; basic PWM dimming cannot achieve complex light effects; adding wireless modules is difficult to solve the battery life problem. These technical defects seriously restrict the practical application effect of LED lamps, so a lamp with combined LED lights is needed now.

### SUMMARY OF THE INVENTION

An object of the present invention is to provide a lamp with combined LED lights. Through exquisite mechanical structure design, efficient intelligent control system and humanized functional configuration, the lamp successfully realizes the organic unity of energy saving, functional diversity and convenient use, and has significant technical advantages and market competitiveness in the field of intelligent lighting, so as to solve the technical problems mentioned in the background technology.

To achieve the above purpose, exemplary embodiments of the present invention provide the following technical scheme: a lamp with combined LED lights, comprising a mounting base, wherein a lamp core tube is threadedly mounted inside the mounting base, a cavity is formed inside the lamp core tube, two groups of side electrical sockets are oppositely formed on both sides of the lower part of the outer arc surface of the lamp core tube, and a bottom socket is formed at the bottom of the lamp core tube;

A control module is mounted inside the cavity corresponding to the positions of the side electrical sockets and the bottom socket, and two groups of batteries are inserted and placed inside the lamp core tube above the control module;

A bottom LED lamp is inserted and mounted at the bottom of the lamp core tube, an LED light strip is inserted and mounted on one side of the lamp core tube, and an audio player is inserted and mounted on the other side of the lamp core tube.

Preferably, a limiting head is arranged at the center of the top end of the mounting base, a window is formed through the mounting base at the center of the limiting head, and an internal thread is formed inside the mounting base.

Preferably, a connecting base is communicated and mounted at the top end of the lamp core tube, an external thread tube is mounted at the top end of the connecting base, an inner insertion tube is mounted through the center of the external thread tube corresponding to the window, the connecting base and the inner insertion tube are inserted and mounted, and the external thread tube is threadedly connected with the mounting base.

Preferably, the control module is respectively provided with electrical jacks corresponding to each group of side electrical sockets and bottom sockets, the bottom LED lamp, the LED light strip and the audio player are all provided with plugs, and the bottom LED lamp, the LED light strip and the audio player are all electrically inserted and mounted with the electrical jacks.

Preferably, a partition plate is arranged between the inside of the mounting base and the external thread tube, an electrical connection hole is formed through the center of the partition plate, and a ventilation hole is formed through one side of the center of the partition plate.

Preferably, a glass sleeve is inserted and mounted at the bottom of the mounting base, the lamp core tube is completely accommodated inside the glass sleeve, and a triangular buckle is movably buckled outside the limiting head.

Compared with the prior art, the beneficial effects of the present invention are as follows:

In terms of structural design, a composite scheme of threaded connection and modular insertion is adopted. The mounting base and the lamp core tube are threadedly connected to ensure structural stability, and a cavity is arranged inside the lamp core tube to accommodate the control module and the battery pack. The bottom LED lamp, the LED light strip and the audio player are all installed by point insertion. This design not only ensures the reliability of electrical connection, but also realizes the quick replacement and free combination of functional components. The connecting base and the external thread tube at the top of the lamp core tube cooperate with the inner insertion tube to form a battery limiting structure. It is powered by standard AAA batteries and can maintain continuous work for 40 days, which significantly improves the practicality and battery life of the product.

Secondly, in the control system, an innovative dual-chip architecture of ESP32 + WS2812B is adopted. The ESP32 serves as the main control chip to handle timing logic and network control, realizing an intelligent energy-saving cycle of automatic shutdown after 6 hours and automatic restart after 18 hours, which can theoretically reduce the operating energy consumption by 75%. The WS2812B chip is especially responsible for the execution of lighting effects, supporting monochrome, color and 8 preset light effect modes. The processor can dynamically adjust the light effect performance of the bottom LED lamp or the light strip. This chip combination with clear division of labor not only ensures control accuracy, but also realizes rich lighting scene applications.

### BRIEF DESCRIPTION OF THE DRAWINGS

FIG. 1 is a schematic diagram of the structure of a lamp according to an exemplary embodiment of the present invention;

FIG. 2 is a schematic diagram of the overall structure disassembly of a lamp according to an exemplary embodiment of the present invention;

FIG. 3 is a schematic diagram of the disassembly of the lamp core tube installation structure according to an exemplary embodiment of the present invention;

FIG. 4 is a schematic diagram of the installation structure of the audio player according to an exemplary embodiment of the present invention;

FIG. 5 is a schematic diagram of the opening structure of the bottom socket of according to an exemplary embodiment of the present invention;

FIG. 6 is a schematic diagram of the disassembly of the battery installation structure according to an exemplary embodiment of the present invention;

FIG. 7 is a schematic diagram of the overall structure of the partition plate of according to an exemplary embodiment of the present invention.

In the figures:
1. Mounting base;
2. Limiting head;
3. Lamp core tube;
4. Connecting base;
5. External thread tube;
6. Inner insertion tube;
7. Side electrical socket;
8. Bottom socket;
9. Battery;
10. Control module;
11. Electrical jack;
12. Bottom LED lamp;
13. LED light strip;
14. Audio player;
15. Partition plate;
16. Electrical connection hole;
17. Ventilation hole;
18. Glass sleeve;
19. Triangular buckle.

### DETAILED DESCRIPTION

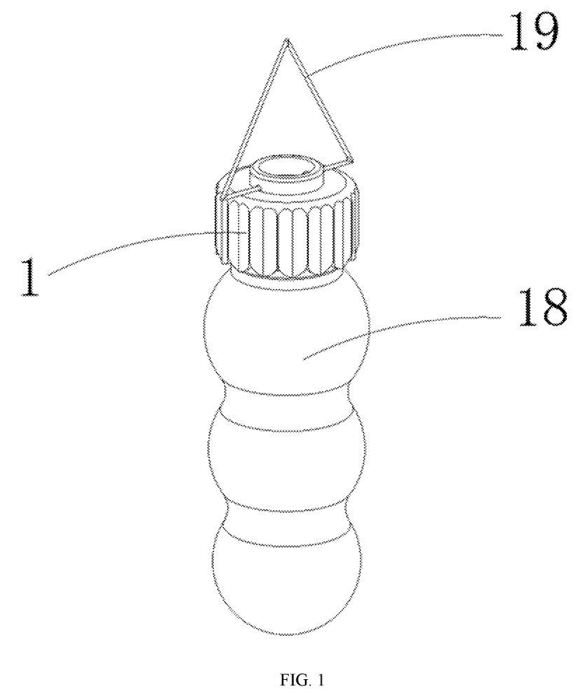

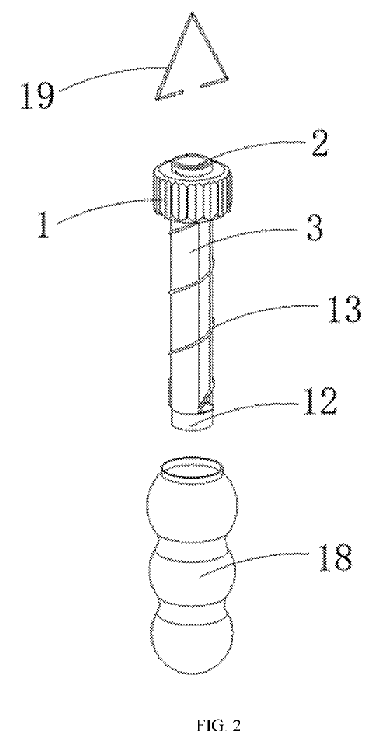

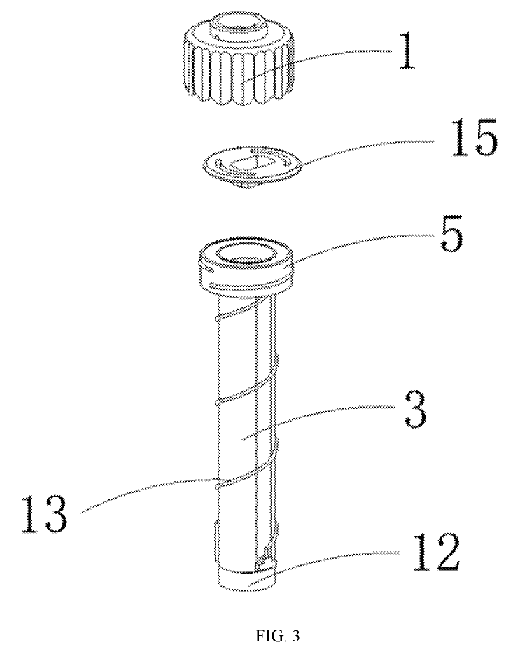

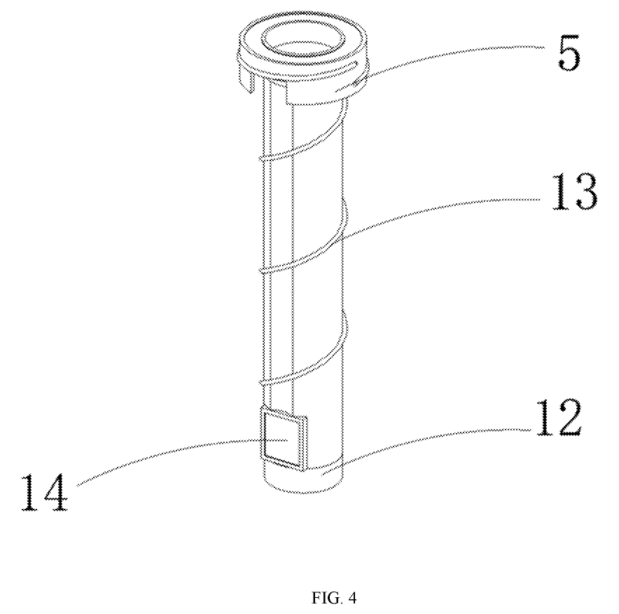

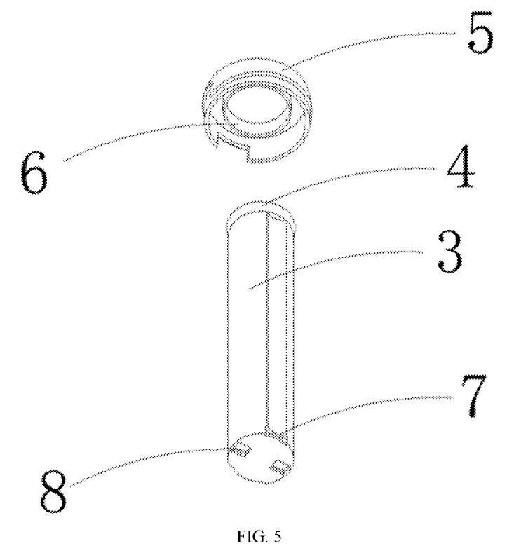

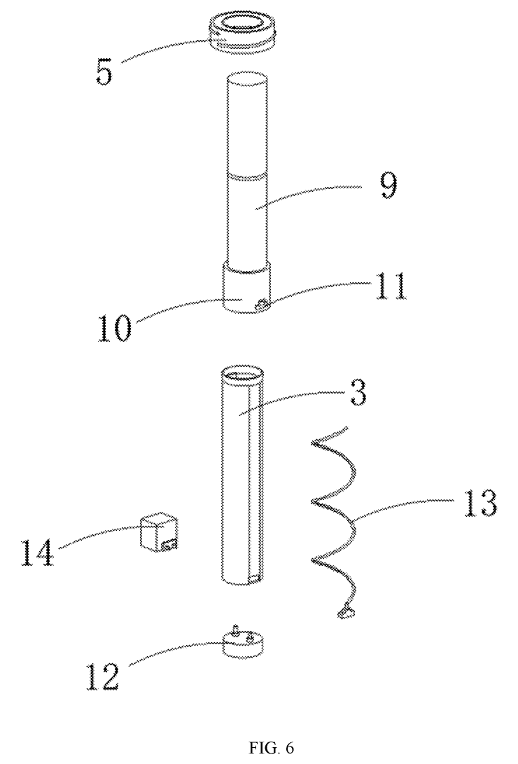

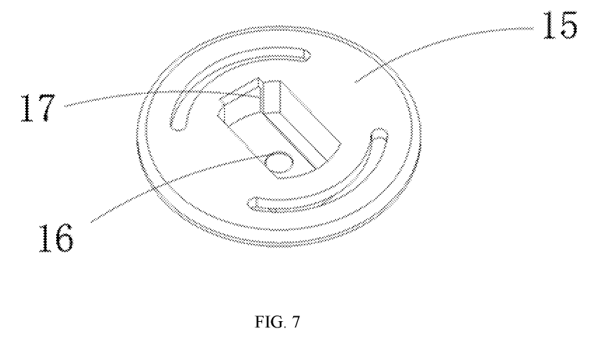

FIGS. 1-7 show a lamp with combined LED lights according to an exemplary embodiment of the present invention. The lamp comprises a mounting base 1, a lamp core tube 3 threadedly mounted inside the mounting base 1, a cavity formed inside the lamp core tube 3, two groups of side electrical sockets 7 oppositely formed on both sides of the lower part of the outer arc surface of the lamp core tube 3, and a bottom socket 8 formed at the bottom of the lamp core tube 3. The mounting base 1 and the lamp core tube 3 are threadedly connected to ensure the stability of the connection between the mounting base 1 and the lamp core tube 3, so as to avoid the overall detachment of the lamp core tube 3 during use;

A control module 10 is mounted inside the cavity corresponding to the positions of the side electrical sockets 7 and the bottom socket 8, and two groups of batteries 9 are inserted and placed inside the lamp core tube 3 above the control module 10. The control module 10 is internally provided with an ESP32 chip, a WS2812B chip and a processor, wherein the ESP32 control module 10 timing chip processes timing logic and network control, the WS2812B is responsible for the execution of lighting effects, the timing chip can be automatically turned off after 6 hours of operation and automatically turned on after 18 hours, which saves electrical energy more effectively. The chip is used to control the color-changing lighting effect, and the processor can change the lighting effect of the bottom LED lamp 12 or the LED light strip 13 to perform various flashes, so as to optimize the diversity of the overall use of the lamp;

A bottom LED lamp 12 is inserted and mounted at the bottom of the lamp core tube 3, an LED light strip 13 is inserted and mounted on one side of the lamp core tube 3, and an audio player 14 is inserted and mounted on the other side of the lamp core tube 3. The set bottom LED lamp 12, LED light strip 13 and audio player 14 can be combined and used according to specific use needs, and any one or more groups can be used in combination to improve the diversity of the overall use of the lamp.

Preferably, a limiting head 2 is arranged at the center of the top end of the mounting base 1, a window is formed through the mounting base 1 at the center of the limiting head 2, and an internal thread is formed inside the mounting base 1. The limiting head 2 on the upper part of the mounting base 1 can limit the overall use position of the lamp, and the window opened at the center of the limiting head 2 can ensure that the internal temperature will not be too high during use, so as to protect the control module 10.

Further, a connecting base 4 is communicated and mounted at the top end of the lamp core tube 3, an external thread tube 5 is mounted at the top end of the connecting base 4, an inner insertion tube 6 is mounted through the center of the external thread tube 5 corresponding to the window, the connecting base 4 and the inner insertion tube 6 are inserted and mounted, and the external thread tube 5 is threadedly connected with the mounting base 1. The connecting base 4 at the top end of the lamp core tube 3 and the inner insertion tube 6 mounted at the center of the external thread tube 5 are inserted and mounted. The two groups of batteries 9 are limited by the set inner insertion tube 6, so that the batteries 9 can stably contact the electrical jacks 11, thereby providing power support for the electrical jacks 11. At the same time, the set insertion method can better ensure the convenience of disassembly and assembly of the batteries 9. The batteries 9 are AAA batteries, which can work continuously for 40 days, greatly improving the service life of the lamp.

Furthermore, the control module 10 is respectively provided with electrical jacks 11 corresponding to each group of side electrical sockets 7 and bottom sockets 8, the bottom LED lamp 12, the LED light strip 13 and the audio player 14 are all provided with plugs, and the bottom LED lamp 12, the LED light strip 13 and the audio player 14 are all electrically inserted and mounted with the electrical jacks 11. The bottom LED lamp 12, the LED light strip 13 and the audio player 14 are inserted into the control module 10 through plugs. The side electrical sockets 7 and the bottom socket 8 opened on the surface of the lamp core tube 3 and the electrical jacks 11 opened on the surface of the control module 10 limit the plugs, so as to improve the connectivity between the bottom LED lamp 12, the LED light strip 13, the audio player 14 and the control module 10, thereby better completing the selection of the use state of the lamp. In addition, since the bottom LED lamp 12, the LED light strip 13 and the audio player 14 are all installed by insertion, it is more convenient to select any combination to optimize the use state of the lamp, and the convenience is also improved in later maintenance and replacement.

It is worth noting that a partition plate 15 is arranged between the inside of the mounting base 1 and the external thread tube 5, an electrical connection hole 16 is formed through the center of the partition plate 15, and a ventilation hole 17 is formed through one side of the center of the partition plate 15. The partition plate 15 separates the mounting base 1 from the lamp core tube 3, improves the stability of the lamp core tube 3 and the mounting base 1 during connection, and avoids the occurrence of thread slipping.

Specifically, a glass sleeve 18 is inserted and mounted at the bottom of the mounting base 1, the lamp core tube 3 is completely accommodated inside the glass sleeve 18, and a triangular buckle 19 is movably buckled outside the limiting head 2. The set glass sleeve 18 protects the lamp core tube 3, and the shape of the glass sleeve 18 can be changed, so as to better improve the ornamental value of its use. The triangular buckle 19 can be installed outside the limiting head 2 to improve the certainty of the overall use and installation position of the lamp.

Although the embodiments of the present invention have been shown and described, for those of ordinary skill in the art, it can be understood that various changes, modifications, substitutions and variations can be made to these embodiments without departing from the principle and spirit of the invention. The scope of the invention is defined by the appended claims and their equivalents.

1. A lamp with combined LED lights, comprising:
a mounting base, a lamp core tube threadedly mounted inside the mounting base, a cavity formed inside the lamp core tube, two groups of side electrical sockets oppositely formed on both sides of a lower part of an outer arc surface of the lamp core tube, and a bottom socket formed at a bottom of the lamp core tube;
a control module mounted inside the cavity corresponding to positions of the side electrical sockets and the bottom socket, and two groups of batteries inserted and placed inside the lamp core tube above the control module; and
a bottom LED lamp inserted and mounted at the bottom of the lamp core tube, an LED light strip inserted and mounted on one side of the lamp core tube, and an audio player inserted and mounted on the other side of the lamp core tube.

2. The lamp with combined LED lights according to claim 1, further comprising a limiting head arranged at a center of the top end of the mounting base, a window formed through the mounting base at a center of the limiting head, and an internal thread formed inside the mounting base.

3. The lamp with combined LED lights according to claim 2, further comprising a connecting base mounted at a top end of the lamp core tube, an external thread tube mounted at a top end of the connecting base, an inner insertion tube mounted through a center of the external thread tube corresponding to the window, the connecting base and the inner insertion tube inserted and mounted, and the external thread tube threadedly connected with the mounting base.

4. The lamp with combined LED lights according to claim 3, wherein the control module is respectively provided with electrical jacks corresponding to each group of side electrical sockets and bottom sockets, the bottom LED lamp, the LED light strip and the audio player are all provided with plugs, and the bottom LED lamp , the LED light strip and the audio player are all electrically inserted and mounted with the electrical jacks.

5. The lamp with combined LED lights according to claim 4, further comprising a partition plate arranged between an inside of the mounting base and the external thread tube, an electrical connection hole formed through a center of the partition plate, and a ventilation hole formed through one side of the center of the partition plate.

6. The lamp with combined LED lights according to claim 5, further comprising a glass sleeve inserted and mounted at the bottom of the mounting base, the lamp core tube being completely accommodated inside the glass sleeve, and a triangular buckle movably buckled outside the limiting head.
